(19) United States
(12) Patent Application Publication
(10) Pub. No.: US 2019/0242607 A1
(43) Pub. Date: Aug. 8, 2019

(54) AIR PURIFICATION DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHUN-KAI PENG, New Taipei (TW); WEI-CHIEN HSU, New Taipei (TW); YING-CHIA TANG, New Taipei (TW); YING-WEI SHENG, New Taipei (TW); CHIA-WEI LIU, New Taipei (TW); YAN-CHANG HE, Shenzhen (CN)

(21) Appl. No.: 16/204,081

(22) Filed: Nov. 29, 2018

(30) Foreign Application Priority Data
Feb. 6, 2018 (CN) 201810117358.0

(51) Int. Cl. F24F 11/52; F24F 3/16; F21V 33/00

(52) U.S. Cl. CPC F24F 11/52; F24F 2110/70; F21V 33/0088; F24F 3/16

(57) ABSTRACT

An air purification device includes a housing, an air quality sensor, an LED light group, and a controller. The air quality sensor is mounted within the housing and detects air quality parameters in real time. The LED light group is mounted within the housing and includes at least one LED light. The controller is mounted within the housing and controls the at least one LED light of the LED light group to emit light of a corresponding color according to the air quality parameters. The emitted light corresponds in color to indicate an air quality.

### FIELD

The subject matter herein generally relates to air purification devices, and more particularly to an air purification device having a light emitting diode (LED) indication system.

### BACKGROUND

Generally, air purification devices, such as home air filter systems, use a display to display information such as a monitored air quality and air quality parameters. However, a user must be close enough to the display to read the information displayed on the display.

### BRIEF DESCRIPTION OF THE DRAWINGS

Implementations of the present disclosure will now be described, by way of embodiments, with reference to the attached figures.

FIG. 1 is an assembled, isometric view of an air purification device in accordance with an embodiment of the present disclosure.

FIG. 2 is an exploded, isometric view of the air purification device in FIG. 1.

FIG. 3 is similar to FIG. 2, but shows the air purification device from another angle.

FIG. 4 is a close-up view of an LED light group and an LED light cover in FIG. 3.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

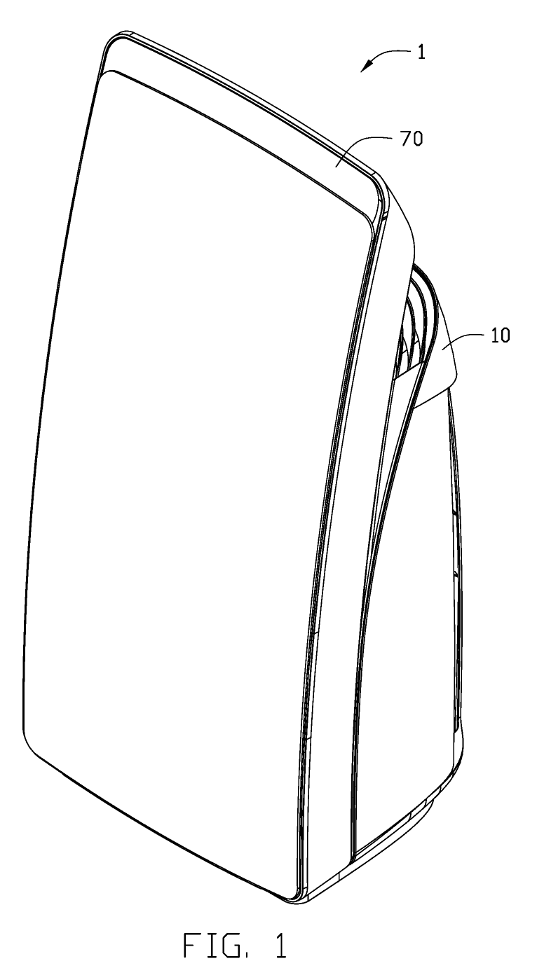

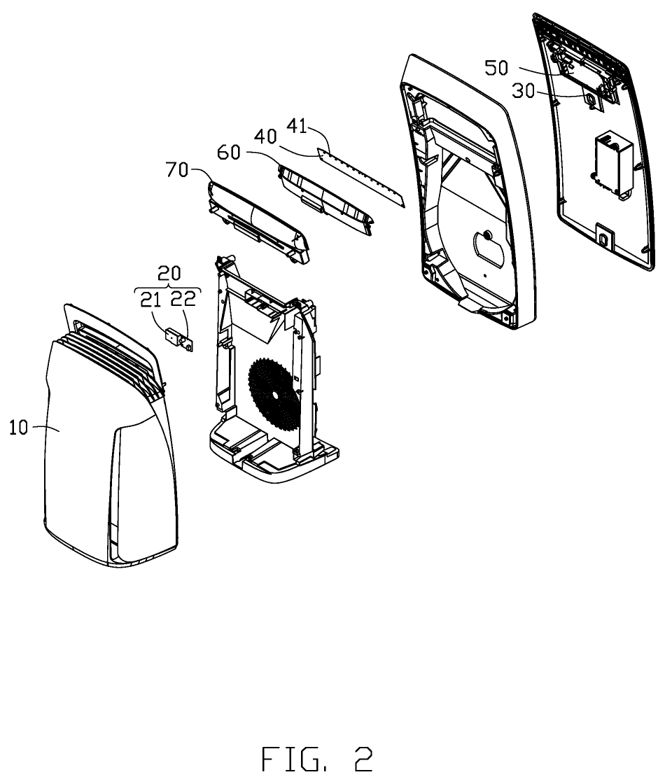

FIG. 1 and FIG. 2 illustrate an embodiment of an air purification device 1. The air purification device 1 includes, but is not limited to, a housing 10, an air quality sensor 20, a controller 30, and an LED light group 40. In one embodiment, the air quality sensor 20, the controller 30, and the LED light group 40 are mounted within the housing 10.

In one embodiment, the air purification device 1 further includes a motherboard 50. The controller 30 and the LED light group 40 are integrated on the motherboard 50. The motherboard 50 includes a plurality of ports (not shown). The air quality sensor 20 is electrically coupled to the ports of the motherboard 50.

The air quality sensor 20 detects air quality parameters in real time. In one embodiment, the air quality sensor 20 includes a dust sensor 21 and an air particle sensor 22. The air quality parameters include at least a dust concentration parameter, a formaldehyde concentration parameter, and a carbon dioxide concentration parameter. The dust sensor 21 detects dust concentration. The air particle sensor 22 detects formaldehyde concentration and carbon dioxide concentration. In another embodiment, the air quality sensor 22 further detects carbon monoxide concentration, methane concentration, and PM2.5 concentration.

The controller 30 determines an air quality grade according to the air quality parameters detected by the air quality sensor 20. In one embodiment, the air quality grade includes, but is not limited to, good, light pollution, and heavy pollution. The air quality grade is determined according to the parameters detected by the dust sensor 21 and the air particle sensor 22.

The LED light group 40 includes at least one LED light 41. In one embodiment, the LED light group 40 includes a plurality of LED lights 41. Each LED light 41 emits at least a light of a first color, a light of a second color, and a light of a third color. In one embodiment, the LED light group 40 includes 13 LED lights 41, the first color is blue, the second color is orange, and the third color is red. In other embodiments, the quantity of the LED lights 41 in the LED light group 40 may be changed according to requirements, and the LED lights 41 may emit lights of different colors according to requirements.

The controller 30 controls the LED lights 41 of the LED light group 40 to emit light of a corresponding color according to the air quality parameters to indicated the air quality grade. In one embodiment, the controller 30 controls the LED lights 41 of the LED light group 40 to emit the light of the first color, such as blue, when it is determined that the air quality grade is good. The controller 30 controls the LED lights 41 of the LED light group 40 to emit the light of the second color, such as orange, when it is determined that the air quality grade is light pollution. The controller 30 controls the LED lights 41 of the LED light group 40 to emit the light of the third color, such as red, when it is determined that the air quality grade is heavy pollution. In this way, a user is able to quickly know at a glance the air quality grade according to the color of light emitted by the LED lights 41.

In one embodiment, when the LED lights 41 emit the light of the corresponding color, the controller 30 controls the LED lights 41 to alternately emit light in gradual increasing and gradual decreasing intensity.

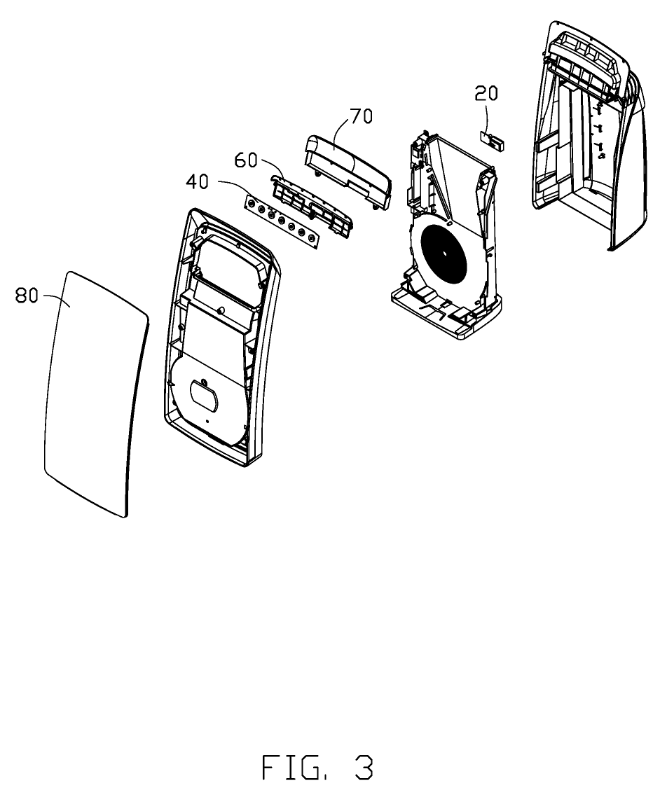

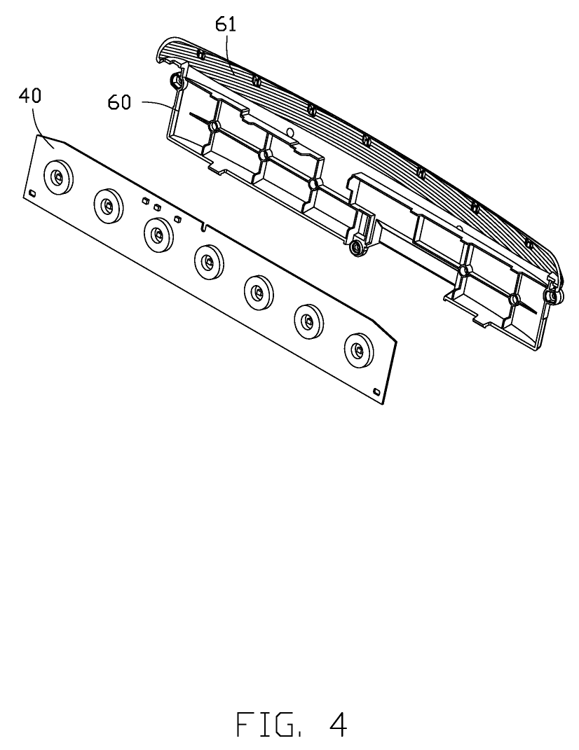

As shown in FIGS. 3 and 4, the air purification device 1 further includes an LED light cover 60. The LED light cover 60 is mounted within the housing 10 to cover the LED light group 40. The light emitted by the LED lights 41 pass through the LED light cover 60. In one embodiment, a surface of the LED light cover 60 forms a ripple pattern 61 for causing the light to emit with a ripple effect. The LED light cover 60 is made of material having high transparency, such as polymethyl methacrylate (PMMA).

The air purification device 1 further includes a refraction plate 70. The refraction plate 70 is mounted within the housing 10 and covers the LED cover 60. The refraction plate 70 refracts the light passing through the LED cover 60. In one embodiment, a surface of the refraction plate 70 is curved inward within the housing 10 and forms a fogged surface for diffusing the light passing through the refraction plate 70. Thus, the light passing through the refraction plate 70 is more evenly distributed to enhance an appearance of the air purification device 1.

As shown in FIG. 3, the air purification device 1 further includes a display 80. The display 80 is mounted to an outer surface of the housing 10 and is electrically coupled to the controller 30. The display 80 displays the air quality parameters and the air quality grade. In one embodiment, the display 80 is an LED display or a liquid crystal display.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An air purification device comprising:
a housing;
an air quality sensor mounted within the housing and adapted for detecting air quality parameters in real time;
a light emitting diode (LED) light group mounted within the housing and comprising at least one LED light; and
a controller mounted within the housing and controlling the at least one LED light of the LED light group to emit light of a corresponding color according to the air quality parameters, the emitted light of the corresponding color indicating the air quality.

2. The air purification device of claim 1, wherein the LED light group comprises a plurality of LED lights, each of the plurality of LED lights being adapted for emitting at least a light of a first color, a light of a second color, and a light of a third color.

3. The air purification device of claim 2, wherein the first color is blue, the second color is orange, and the third color is red.

4. The air purification device of claim 2, wherein the controller further determines an air quality grade according to the air quality parameters detected by the air quality sensor.

5. The air purification device of claim 4, wherein the air quality grade comprises at least good, light pollution, and heavy pollution.

6. The air purification device of claim 4, wherein:
the controller controls the plurality of LED lights of the LED light group to emit the light of the first color when the controller determines that the air quality grade is good;
the controller controls the LED lights of the LED light group to emit the light of the second color when the controller determines that the air quality grade is light pollution;
the controller controls the LED lights of the LED light group to emit the light of the third color when the controller determines that the air quality grade is heavy pollution.

7. The air purification device of claim 1, wherein:
the air quality sensor comprises at least a dust sensor and an air particle sensor;
the air quality parameters comprise at least a dust concentration parameter, a formaldehyde concentration parameter, and a carbon dioxide concentration parameter.

8. The air purification device of claim 1, wherein the controller controls the plurality of LED lights of the LED light group to alternately emit light in gradual increasing and gradual decreasing intensity.

9. The air purification device of claim 1, further comprising an LED light cover covering the LED light group, wherein light emitted by the plurality of LED lights of the LED light group passes through the LED light cover.

10. The air purification device of claim 9, wherein a surface of the LED light cover forms a ripple pattern, and the light passing through the LED light cover emits as a ripple pattern.

11. The air purification device of claim 9, wherein the LED cover is made of material having high transparency.

12. The air purification device of claim 9, further comprising a refraction plate covering the LED light cover, wherein the light passing through the LED light cover further passes through the refraction plate.

13. The air purification device of claim 12, wherein a surface of the refraction plate forms a fogged surface, and the light passing through the refraction plate is dampened by the fogged surface.

14. The air purification device of claim 1, further comprising a display displaying the air quality parameters.
